(19) United States
(12) Patent Application Publication
(10) Pub. No.: US 2011/0109089 A1
(43) Pub. Date: May 12, 2011

(54) Free-flow hydro-powered turbine system

(76) Inventor: Clarence Edward Frye, Blountville, TN (US)

(21) Appl. No.: 12/658,761

(22) Filed: Feb. 12, 2010

Related U.S. Application Data
(60) Provisional application No. 61/272,131, filed on Aug. 19, 2009.

(51) Int. Cl. F03B 13/10

(52) U.S. Cl. 290/54

(57) ABSTRACT

The enablement is a submerged hydro-powered electrical generating plant powered by the raw power of ocean currents by using the natural motive forces of nature, when submerged within a moving ocean current. A turbine driven electrical generator (preferably a Pelton wheel impulse turbine), with a transformer are all located in an enclosing water tight structure, extended downward from a floating surface operating platform. The prime mover, which is a water supply from incoming ocean currents, applies that force to a turbine, then is exhausted as spent water through a conduit exhausting system that feeds into an entrainment chamber of a Venturi/Eductor jet pump assembly. The motive force for the pump is the incoming ocean currents. The spent water exits the pump as a discharge back into the downstream current. On the power side, the force for this embodiment is derived from the velocity of the moving current and the pressure and mass volume of the depth flowing through the turbine unit and rotating the electrical power generator. This enablement makes available the energy of moving water which can be used to power other embodiments within or outside the structure or above the surface of the water, such as desalination of water by reverse osmosis membranes or electrolysis of water to create hydrogen as a liquid fuel and oxygen as a byproduct, or any other technological process. It is applicable to any comparable moving fluid source, particularly water. This enablement performs the same function as an underwater hydro-powered dam, capable of producing electrical energy, without consuming fossil fuels or causing adverse environmental or economic effects. It can achieve even higher pressures (head) as a motive force to drive its turbine, if it is coupled and operated as a combined system, which includes a means for hydraulic pressure

### CROSS REFERENCE TO RELATED APPLICATION

This application claims all the benefit of the following U.S. Provisional Application Number:

| | | | |
|---|---|---|---|
| No. | 61/272,131 | 19 Aug. 2009 | FREE FLOW HYDRO-POWERED |

| | |
|---|---|
| Foreign License No. 61/272,131 | TURBINE SYSTEM |

### CROSS REFERENCE TO RELATED PATENTS

| | | |
|---|---|---|
| No. 233,692 | 26 Oct. 1880 | PELTON WHEEL |
| No. 7,240,631 B1 | 10 Jul. 2007 | Loop Ballast Exchange System |
| | | for Marine Vessels |
| No. 6,766,754 | 27 Jul. 2004. | Ballast Exchange System For |
| | | Marine Vessels |
| No. 6,053,121 | 25 Apr. 2000 | Method and Apparatus for ex- |
| | | changing Ballast water in a ship |
| No. 7,291,936 B1 | 6 Nov. 2007 | Submersible Electrical Power |
| | | Generating Plant Hydroelectric |
| | | Device |

### CROSS REFERENCE TO RELATED PATENT APPLICATION

| | | |
|---|---|---|
| No. 0,320,459 A1 | 31 Dec. 2009 | HYDRO-ACTUATED |
| | | ENGINE |

### SCHOLARLY REFERENCES

Elementary Mechanics of Fluids, by HUNTER ROUSE, Dover Publications, Inc. (1946);
Handbook of Natural Philosophy: Hydrostatics, Pneumatics and Heat, by DIONYSIUS LARDNER, London Press (1855);
A History of Technology, Volume 5, Edited by CHARLES SINGER, E. J. HOLMYARD & TREVOR I. WILLIAMS, Oxford University Press, 1958;
History of Hydraulics, by HUNTER ROUSE and SIMON INCE, Dover Publications, Inc., 1963;
WIT Translations of State of the Art in Science and Engineering, Volume 25, by S. FRANZETTI, M. GRECO, S. MALAVASI and D. MIRAUDA, WIT Press, 2006;
Ocean Passages of the World, by The Hydrographic Department of the British Admiralty, 1950
The Pelton Wheel (2010, Jan. 26). In Wikipedia, the free encyclopedia. Retrieved Feb. 4, 2010. http://en.wikipedia.org/wiki/Pelton_wheel;

### FIELD OF THE INVENTION

The presently disclosed enablement is a new Paradigm of hydro-power generation. The effect of this enablement is to replicate and exceed the capabilities of the hydro-powered dams of the World, which presently produce 20% of the Earth's electrical power. The effect of this enablement is to create an underwater hydro-electric dam, without consuming any fossil fuel or other type of non-renewable energy source and without the limitations, construction costs or adverse environmental or economic effects. There is no practical limit on the number of these generating plants, which can be placed in ocean currents or in rivers around the Earth to provide unlimited energy for mankind for as long as the World exists.

The decline in the production of both world oil and North American natural gas—combined with catastrophic global warming—have created an urgent need to switch from fossil fuels to those energy sources that are sustainable and non-polluting. Ocean currents flow at all depths, with the strongest usually occurring in the upper layer, which is shallow compared to the depth of the oceans. The main cause of surface currents in the open ocean is the warming of the ocean by the Sun, the rotation of the Earth and the action of the wind on the sea surface.

Winds of high constancy, blowing over great stretches of an ocean, have the effect of producing current. It is for this reason that the northwest and southeast trade winds of the two hemispheres are the mainsprings of the ocean's surface current circulation. In the Atlantic and Pacific oceans, the two trade winds drive an immense body of water westwards over a width of some 50 degrees of latitude, broken only by the narrow belt of the east-going Equatorial Counter-current, which is found a few degrees north of the equator in both of these oceans. A similar westward flow of water occurs in the South Indian Ocean, driven by the southeast trade wind. These westward surface currents produce giant eddies that are centered in latitudes of approximately 30 degrees N. and S. that rotate clockwise in the northern hemisphere and counter-clockwise in the southern hemisphere. Currents of over 3.5 mph are confined to very restricted regions. They have been recorded in the equatorial regions of the oceans, and in the warm currents flowing to higher latitudes in the western sides of the oceans. Any of these currents would provide a suitable placement for this enablement. Ocean Passages of the World (published by the Hydrographic Department of the British Admiralty, 1950), lists 14 currents that exceed 3 knots (3.45 mph), a few of which are in the open ocean.

The Gulf Stream, the Kuroshio and the Antarctic Circumpolar Current are the currents having velocities above 3 knots that flow throughout the year, the strongest currents recorded for the Gulf Stream and the Kuroshio in nautical miles per day. These speeds are equivalent to 156.5 statute miles per day (6.52 mph) for the Gulf Stream, and 133 statute miles per day (6.375 mph) for the Kuroshio. Because these speeds were determined by how far the current carried floating objects in 24 hours, they do not reflect the maximum current speeds at specific times or places. Both the Gulf Stream and the Kuroshio are currents that are driven by the Coriolis force that is produced by the earth's eastward rotation acting upon the ocean currents produced by the trade winds. Because these currents are caused by the earth's eastward rotation, they will continue flowing through the Straits of Florida for as long as our planet continues to turn on its axis.

The Gulf Stream starts roughly where the Gulf of Mexico narrows to form a channel between Cuba and the Florida Keys. From there the current flows northeast through the Straits of Florida between the mainland and the Bahamas, flowing at a substantial speed for some 400 miles. It hits peak velocity off Miami, where the Gulf Stream is about 45 miles wide and 1,500 feet deep. There the current has reached a speed of as much as 7.75 mph in its narrow central axis. Although the peak current velocity of the Gulf Stream may at times exceed 7 mph in its narrow axis off of Miami, the most likely velocities for those turbines placed in its central axis would most probably be between 4.75 and 6 mph.

Embodiments in the Gulf Stream or other strong ocean or river current will generate power, whether or not there is any demand for their electricity. Because they would operate best under steady loads and because their operating costs would be extremely low, the power they produce could be far in excess of that required by the grid during peak hours and the excess could be used to produce off-site energy in other forms. This could include the charging of batteries to power vehicles and the production of hydrogen for hydrogen powered, non-polluting vehicles. Common energy efficiencies for the electrolysis of water are at about 65%. However, by using catalysts in the water electrolyte, efficiencies of 80% to 85% are possible. The amount of hydrogen that can be produced by this method is directly proportional to the amount of electricity used. Instead of adding more gas-fired generating capacity to handle the periods of peak demand, we should strive to generate more than enough power from this enablement to exceed the required energy to cover the peak loads and then add additional loads to fully utilize the surplus generating capacity during periods of low demand from the grid.

In this way, not only can this submersible enablement minimize the need for fossil fuels to produce electricity, they can produce electricity for recharging the batteries of “plug-in” hybrid vehicles and hydrogen to power fuel-cell vehicles. Producing hydrogen by electrolysis can eliminate the need for a hydrogen transportation infrastructure because the hydrogen can be produced from water at local fueling stations during off-peak periods. Every kilowatt-hour of electricity that is generated by water, wind, and other renewable-energy sources can replace the same unit of electricity that is presently being generated by burning fossil fuels. Based on a study in the UK, that determined the carbon dioxide emission of their fossil-fuel plants, each of the submersible electrical power generating plants, having a design capacity of 1200 kilowatts and operating with a 90 percent capacity factor, would reduce the carbon dioxide emissions by roughly 8,100 US tons per year from that produced by the fossil-fuel plants producing the same amount of electricity.

The conventional method of generating power is the hydro-electric generating dam, which has been around for many years, without any major conceptual breakthrough until this enablement. Even though the awesome force of moving water has been harnessed by conventional methods for many centuries, there are some significant disadvantages. Hydro-Electric dams are enormously costly to build, can only be located in a very limited number of locations and can have many adverse environmental impacts.

Various newer methods of generating power from moving bodies of water have been proposed or actually used. At this time 20 percent of the world's electricity is generated by surface water dropping in elevation and flowing through turbines to produce hydro-electric power. There are certain elements that are essential and common for generation of electrical power from all of these systems:
A flowing source of water down-hill from gravitational pull or from natural forces as ocean currents which can flow into a turbine;
Water strike and turns the blades of a turbine which rotates the shaft of a power generator;
The shaft rotation through the generator creates a flow of electrons as an electrical current;
The electrical current is processed through a transformer to produce a voltage suitable for transmission onward;
The water is discharged as a downstream water flow;

Before this enablement, the standard form of hydro-power in the past was the hydro-electrical dam, with a series of turbines fed by a penstock from an impounded body of water. The pump storage facility is a variant on the basic form. An earlier form was the Niagara Falls with the diverted water supply on the Canadian side with turbine wheel pits dug on the sides with tunnel discharge into the river below the falls.

### SUMMARY AND BACKGROUND OF INVENTION

This invention generally relates to a system of capturing and providing energy from moving bodies of water in the ocean. It is understood that energy is the basis of civilization as we know it. The demand for energy is insatiable. In the present circumstances, our primary source is by fossil-based fuels, which are not environmentally friendly and are finite in quantity. Finding renewable, environmentally friendly sources of energy is a matter of national security.

This invention, a free-flow hydro-powered turbine and water jet pump system, captures and transforms the energy of ocean currents. It uses existing technologies, natural forces of wind and gravity, and the unique molecular properties of water. When these forces and the technologies are properly employed, they enable a pressure differential to be established in a infinite pool of renewable energy in as much as energy can neither be created or destroyed. The advantage offered is the system consumes no matter. This system is portable and ready to generate electricity.

Our Earth is a water planet. Within the oceans are moving masses of energy as ocean spanning currents with crushing pressure, due to depth. If mastered, the benefits are incalculable. In the Straits of Florida, the Gulf Stream, a moving body of water within the Atlantic Ocean, reaches depths of 2,000 feet and moves at the rate of about 6 miles per hour. Also impounded bodies of water, held by hydroelectric dams are a vast source of energy. These renewable energy sources, powerful beyond belief, will be with us long as the Earth exists.

Hydropower is measured according to the amount of power released, or energy per unit time. Most hydropower comes from a mass, flow rate and/or pressure due to weight (head) effects of elevation changes. This invention, free-flow hydro-powered turbine system, when placed within an ocean current, serves as a leveraging machine to develop mechanical energy to drive a turbine, which converts hydropower to mechanical energy.

This invention relies on (1) the incompressibility of water and its mechanical properties, and (2) natural forces that assure the intake of water into the penstock leading to the turbine blades and the motive force to support the vacuum effects of its Venturi jet pump exhaust system. Gravity and other natural forces of nature assure the intake of water into the input ports as hydrostatic pressure together with a continuous water flow as a motive force for the Venturi Principle exhausting system.

This system transforms kinetic energy into mechanical energy by rotating the turbine blades which in turns rotates the shaft in the generator. The result is the flow of electrons from eternally free-flowing ocean currents.

Reference is made to related patent application 20090320459, dated 31 Dec. 2009. The Hydro-actuated engine was developed specifically to be an adjunct to be installed as a functioning component for this enablement. When added at mid-point in the pressure side of this enablement, it would function as a 2^{nd} stage pressure feed for the turbine, preferably a Pelton Wheel turbine. The advantages offered by hydraulics are they provide for force-multiplication of pressure and by so doing reduce the volume of water required to drive the turbine of this enablement. Since the Pelton Wheel is best suited for a water supply that is slow flowing with a high pressure level, the addition of the Hydro-actuated engine would offer another advantage for this enablement and the further development the Pelton Wheel's potential. The limiting factor has been the availability of greater pressure levels. The use of hydraulics would remove this barrier. There is no theoretical barrier for realizing the potential of the Pelton Wheel as a turbine to drive more powerful electrical generators.

### PRIOR ART

A careful reading of the principles, scientific tests, and design features of the three following Patents, proves the functionality of the basic premises of this enablement. These Patents are designed to control motive flows of seawater provided by a moving ship into, thru and from systems that use pressure differentials provided from streaming currents, are comparable to the natural ocean currents used to power this enablement, within a submerged environment.

Both the Patents and this enablement bring a motive force by an input port and then, by an exit port, return the water to its natural state in the ocean. In the case of this enablement, and U.S. Pat. No. 7,240,631 B1, the natural law which makes them possible is the Venturi/Eductor principle. The proprietary basis for U.S. Pat. No. 7,240,631 B1 rests solely on this principle, as embodied in its claims. By attribution, the same can be said for the essential claim made in this enablement.

The common purpose shared by all of the following patents and by this enablement, is the use of moving water to enter a submerged inlet port, as a motive force, and then proceed to discharge the water outside to the ocean. The following Patents, including U.S. Pat. No. 7,240,631 B1, unlike this enablement, result from the forward motions of ships and consume fossil fuels necessary to propel them through the water. Conversely, the Gulf Stream and other ocean currents are natural raw energy sources which are the motive power of this enablement, infinite without any disadvantages, and a perfect energy source.

As is apparent to one of ordinary skill in the art, the rate of ballast water exchange (for these Patents or this enablement) depends upon a number of variable factors, including the diameter of the intake ports, the diameter of the discharge ports, the motive power flow rates, the capacity of the pump, and other factors. The determination of these variables and the necessary calculations required to effectuate the practice of the method and the system of the invention in (either the patent or the enablement) under specific operating conditions are well within the ordinary skill of those working in the art.

Thus, prior art is also applicable to mechanical valves or associated adjuncts, electronic control devices or general purpose computers, which input and process system-wide data needed to effectuate the purpose of this enablement. In fact, although this enablement utilizes the principles in a different way than ever before used, the functionality of these principles used in this enablement have been proven from similar uses of the same technology in prior art references and in these Patents.

Furthermore, all three of the following Patents utilize the same principles as this enablement to achieve the exchange of ballast for ocean going vessels without requiring the use of discharging pumps. U.S. Pat. No. 7,240,631 B1 proves that the Venturi/Eductor is capable of creating this hole and maintaining it. In that Patent, it is stated that the Eductor can move one cubic meter of water per minute, or more, from a ballast tank in a vessel. There is no difference whether it is taking water out of a ballast tank or removing it from a turbine. In both cases, they are returning the water back into its natural environment. However, the enablement, for the first time ever, uses these principles for the generation of hydro-electrical power from an infinite free source. The secret of this enablement is its ability to “open a hole” in the ocean and permit the water to continuously flow, unimpeded through the system. In so doing, it drives the turbine, which in turn, transforms the energy from the water into electrical energy. It is a perfect energy source and the perfect solution to Earths environmental problems.

The function of U.S. Pat. No. 7,240,631 is to exchange seawater as ballast for marine vessels such as large crude carriers by emptying it back into the sea. The exchange (emptying) function is done by a Venturi/Eductor jet pump, the same device as is used in this enablement. The function is the same, whether emptying a ballast tank in the case of the above Patent or unloading spent water from a turbine driving an electrical generator as in this enablement. The motive force in the patent is the forward motion of the ship. In the case of the enablement, it is the incoming flow of a strong ocean current. In either case, the force enters the inlet pipe and then moves as a motive force thru the Venturi/Eductor, after which the water is emptied back into the sea.

As demonstrated in this Patent, the preferred flow rate of water discharged through the Eductor is one cubic meter per second (over 200 gallons per second). This Patent goes on to say that this flow rate could easily be increased, thereby achieving the necessary flow rates that could be utilized in this enablement.

The Eductor is an ejector device that uses a high pressure motive fluid to create a low pressure zone and remove a lower pressure liquid from its supplier (tank or turbine). It differs from a conventional pump since it has no moving parts. It may be fabricated from any non-corrosive materials, such as PVC or such.

U.S. Pat. No. 6,766,754 exchanges seawater as ballast for marine vessels such as large crude carriers. This Patent relates to controlling the intake, exchange and discharge of seawater ballast from marine vessels such as VLCC, container ships, oil tank ships and the like. Large volumes of water must be introduced into the vessel's ballast tanks and the loading must be done as quickly as possible, due to the large demurrage fees associated with the inefficient loading or idling of commercial marine vessels. As prior art, U.S. Pat. No. 6,053,121 demonstrates and proves beyond any doubt the use of a bow port intake that uses the difference in hydrodynamic pressure for effecting the exchange while the ship is underway and its subsequent outside discharge.

This Patent, which is currently being employed in ship building technology, uses the same principles which are applicable to this enablement, thereby proving that they will work under the similar conditions required by this enablement. In the Patent, the motive force is the forward motion of the ship. In contrast, the motive force of the enablement is the raw energy delivered by an oncoming ocean current. But the principles utilized are the same.

U.S. Pat. No. 6,053,121 exchanges seawater as ballast for marine vessels such as large crude carriers. This patent provides a system for exchanging ballast water on a ship to stabilize the vessel. Conventionally, the ballast is exchanged by using a pump. According to this invention, the exchange can be achieved by placing a seawater inlet port on a part of the ship where the water pressure, acting on the ship when it is in forward motion, is higher than the pressure of the water to be replaced. A water discharge port in the bottom of the ship, when opened, discharges the water back into the stream flowing by the vessel. This patents advantage is that the ballast water can be exchanged without the application of any power, other than the power generated by the moving ship, thereby avoiding (fossil fuel) energy cost involved in the exchange. Scientific tests conducted in conjunction with this Patent proved that the entire system worked in all respects.

### PRINCIPLES OF PHYSICS UTILIZED IN THIS EMBODIMENT

Molecular energy is a property of water as stated in Pascal's Law. Its molecules are constantly moving. They slip and slide past one another even when they are at rest in their passive form. The movement of molecules in the water is molecular energy. The inexhaustible quantity of molecular energy in a body of water becomes the kinetic force which powers this enablement.

The turbine blades are levers functioning as fulcrums in response to the water force created axial torque.

The Venturi Principle embodied in the form of a jet pump, addresses the exhaust function.

Bernoulli's equation states that when water flows as a streamline through a pipe with a smoothly varying constriction, the flow will gain speed with lowered pressure while passing through the constricted area (narrow space known as a Venturi tube). This creates a vacuum. A pipe (known as an Eductor) leading from the turbine to the Venturi tube will suck fluid (as water) up and entrain it with water flowing thru the tube for discharge.

When placed at depth, gravity exerts pressure on every square inch of a solid's surface area of exposure. Therefore, external ambient pressure must be resolved in a submerged environment. This enablement, utilizing the Venturi\Eductor principle, for the first time makes the inherent energy of the World's oceans available by transforming their kinetic energy into electrical energy. It does this by returning the spent water from the turbine back into the downstream flowing current. Thus, the water is not consumed. Instead, it merely passes through this enablement, moving the turbines and generating electricity in the process.

Mechanical energy is the link, which applies hydraulic energy to a generator workload and causes a flow of electrons.

### SITE LOCATION FOR INVENTION

This generating plant with its exhausting Venturi jet pump system needs a moving water mass as its prime mover, the gravity intake of a hydroelectric dam penstock, or a fluid pressure equivalent. Its purpose is to harness the potential energy present in moving bodies of fluid. We believe this invention is the first free-flow hydro-powered system on an industrial size scale capable of harnessing ocean currents.

Water with a fulcrum is in fact a Machine. All this system requires is a water flow force with a means of passing it thru a turbine, and exhausting it back into the moving ocean current.

The untapped source of water force is ocean currents, such as the Gulf Stream and other ocean currents, due to massive water flows. The movement of water and depth found in ocean currents is self evident, as is its powerful force.

### DRAWINGS

### Background

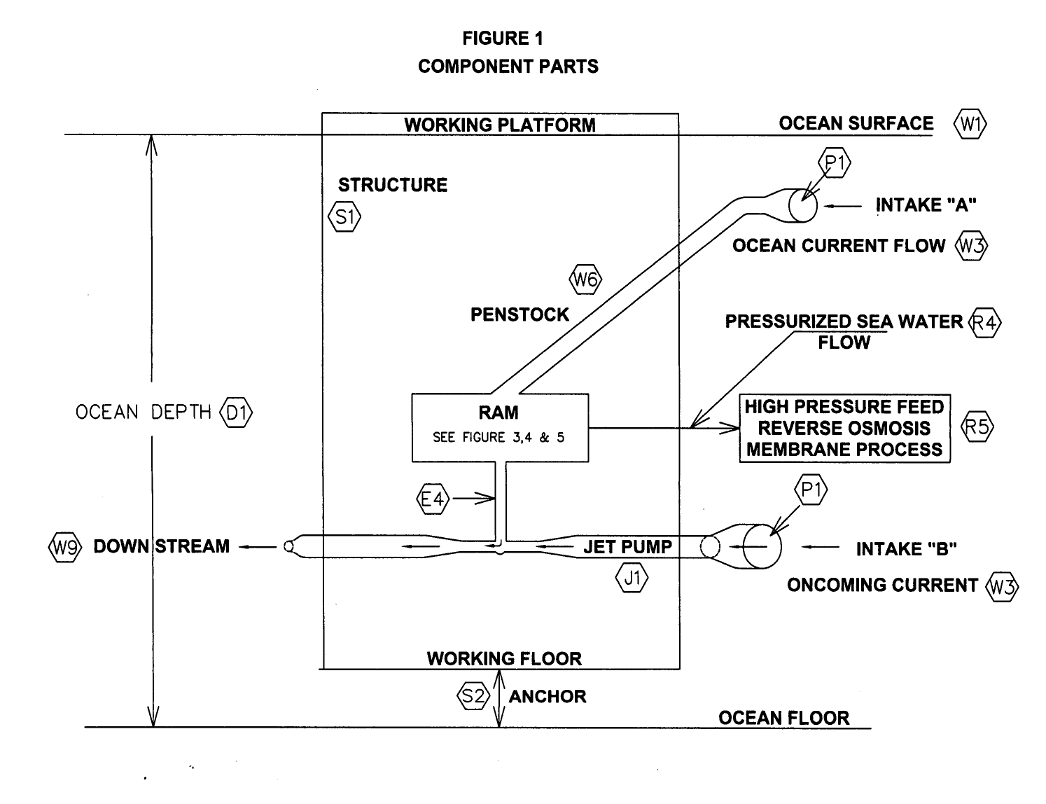

The system is placed at a depth within a body of moving water. Its components are either housed within a supporting structure or submerged in the water itself. The system is stabilized by appropriate structural support members. The support system is a function of dimensions and pressure/volume capabilities for any application. The specifications layout must include all components shown in FIG. 1, with the faithful observance of all narrative text, which describes all aspects of this enablement and embodiment.

The system, being robust and expandable, can be designed and fielded as complete plants, preferably in industrial sized versions.

### DRAWING

### Figure

W1 The upstream water supply which provides the motive force as a prime mover of the hydro-actuated engine (when installed), turbine and Venturi jet pump. The water force enters the system at multiple points: the (P1) penstock entrance and the (P1) Venturi tube entrance;

W2. Vertical indicator of hydrostatic water pressure head which would overlie the enablement, when submerged at depth in a body of water;

W3. The flowing water current which surrounds the structure housing the power generating components and the Venturi/Eductor jet pump assembly;

W4. The downstream water flow which has passed the enablement by and is moving the water discharged from the jet nozzle exit point (E5) away with it;

A1& A2. The structure, the equivalent of a turbine wheel pit or operating floor, which houses a generator and transformer for movement of the electron flow, electricity in a suitable voltage for transmission onward by an off-shore power grid;

A1. That part of the structure which resides above or on the surface of the body of water;

A2. That part of the structure within the body of water which supports the turbine wheel pit floor and general work support area;

A3. The turbine wheel pit floor and work area. The water supply, the motive force for the turbine enters from the penstock (P2) into the turbine and exits via the tail-race (P5) where it is dumped into the (E1) Venturi jet pump for discharge;
P1. Shrouded entrance and entry port of the moving high pressure water flow used as the motive power source for the turbine, feed penstock and for the Venturi jet pimp;
P2. The penstock feeds the pressurized water supply into the turbine. This force, upon entering the shrouded port (P1) then proceeds to (P2). It may be either from the outside ocean currents or at midpoint, from which the pressure can be further increased, if it is coupled and operated as a combined input system including a hydraulic means for pressure multiplication (head). Also having an unlimited water supply from the ocean currents, it effectively removes design limitations on the size of the turbine runners thereby increasing the generating capacity of the system;

P3 & P4. Manually (A3) operated valves located within the structure which permit or deny entry or exit movement of the water supply thru the system;

P5. This is a penstock which feeds the discharge water through the Venturi jet pump;

E1. The Venturi Eductor jet pump system discharges water exiting from the turbine;

E2. The shrouded entrance port for entry of the water mass as a motive force into the Venturi Eductor jet pump system;

E3. The smooth pipe first sections of the Venturi exhaust system;

E4. The smooth pipe final sections of the Venturi exhaust system;

E5. The exits section of the Venturi exhaust system terminating with a jet nozzle for ejecting the water mass back into ambient the flowing water mass environment;

E6. This is the area near the mouth of the jet nozzle experiencing a constant vortex/turbulence event with a lowered pressure differential. The turbulence is caused by the water mass flowing along the external surface of the exit point, which is a form of resistance as a physical object with a blunt shaped end impeding its path of flow. This event, in the continuous flowing water mass, facilitates the reentering of motive and entrained drainage water exiting the Venturi Eductor exhaust system.

### COMPONENT DESCRIPTION & OVERVIEW OF INVENTION

All references made herein are to items as identified on the FIG. 1 drawing.

This invention is in all respects is a hydro-electrical power plant which is used as an embodiment in the ocean currents. It uses the natural force of the ocean currents (W1 & W2) of the earth, an infinite source of renewable energy. It does not consume matter. It transforms energy states. When operated at a depth, is in fact, an infinite molecular power source. The components of the system are:
Body of flowing water;
A turbine placed at depth;
A Venturi/Eductor jet pump;
Electrical generator and transformer;
A structure to house the turbine and to control the flow of water supply in an enclosing area to move thru the system, consisting of the components described herein to constitute an entire physical plant, the upper portion of which resides on and above the surface of the water, that is secured from moving a fixed position in relation to the sea floor and that is oriented so the input points face the incoming downstream current and in proper relationship to the offshore power grid electrical distribution system. Furthermore, it must be extended downward to the desired operating depth to provide the pressure to operate the system;

It operates in an environmentally friendly way of delivering electrical power. It simply changes raw water energy into a usable form. Capability is determined by turbine size and the capability of the Venturi jet pump to return the discharge flow into the downstream environment.

To begin, the free-flow hydro-powered system is positioned partially within a structure (as depicted) and submerged in a body of flowing water, at a depth and positioned by sea floor attachment or tether. The system's shrouded intake ports must be oriented so as to be directly facing the oncoming stream of flowing water. The exit or discharge point of the jet pump faces downstream.

The (T1) turbine runners act as fulcrums with (W1) water pressure flowing across them acting as long levers to mechanically turn a (T2) axle. The axle, in turn, spins an electrical generator to produce an electron flow for voltage conversion by a transformer for onward transmission.

The (W2) hydrostatic head is further increased as a force by the velocity of the upstream (W1) moving current entering the shrouded entry port (P1). The force entering the shrouded port (P1), which may be either from the outside ocean or from the pressurized water output from one or more Hydro-actuated Engines (Publication Number 0320459 A1, 31 Dec., 2009), arranged in an array for greater combined function, proceeds via (P2) penstock to the turbines and power units, where it impresses its force against the resistance of the generator workload.

The (W1) water force from the flow of the ocean current enters the system at two (P1 & E2) shrouded ports oriented to receive the pressurized head of water. At (P1) port the conduit routes the water force through a down sloping tube to the turbine chamber and at E2 port the conduit routes the water through the Venturi/Eductor discharge system.

The power units (T1) convert water pressure into mechanical energy by rotating a (T2) shaft attached to an electrical generator. The expelled water mass leaves the turbine via an exit (P5) equivalent to a tail-race conduit.

The jet-pump observes these basic principles of fluid dynamics. A stream of water (or fluid) is its prime mover, as it is in this enablement. In FIG. 1 (W1 & W2), water flows thru a conduit or pipe shaped in the form of a Venturi. The water (fluid) accelerates as kinetic energy velocity, streaming past points E2, E3, & E4, entraining a secondary water flow from (P5) and in (E1). This secondary stream is a discharge from the turbine and mixes with the primary (motive) stream.

The system has two on and off values (P3 & P4) responding to manual opening and closure. They deny or permit the water to enter or exit the turbine. The purpose is to start/stop the operating mode on command.

This invention uses the Venturi Principle jet pump as its exhaust system. The embodiment has a continuous stream of water running through it at all times as it motive force.

The Venturi/Eductor assembly, as the system's integral exhausting system, is equivalent to the suction side of the typical fossil fuel powered prime mover found in millions of ordinary hydraulic circuits, which are typical linear motors. Drainage water is discharged thru a jet nozzle in the exit portion of the Venturi exhaust pipe into the outside body of water flowing past outside the discharge point. The jet stream produces a turbulence area, or vortex area of cavitations.

The Venturi tube is based on the long known theorem of Bernoulli, in that a liquid flowing from left to right between point A and point B in a smooth pipe in a decreasingly tapered constriction, that the velocity increases and the pressure correspondingly decreases. There is a simple relationship which exists, as volume falls the velocity increases and that as it moves from further point B to point C, the volume increases and the velocity decreases. The velocity at point B, in the (E1) constricted area can produce a vacuum which is the basis for the Eductor suction function. When the vacuum is applied to the tail-race at (P5), the enablement, can drain the spent water from the turbine.

The Venturi assembly (E1) is a tube or pipe, with its entrainment chamber, permits the (A1) water mass to flow thru it continuously as a motive power source. The motive power flow (P1) enters a shrouded entry port (E2). This creates suction in (P5) an Eductor conduits which are connected to the Venturi tube (E1) where the drainage from the turbine is mixed into the (W1) motive power stream of flowing water.

The critical spent water exhaust function is achieved by a drainage system using the Venturi Principle (E2,3,1,4 & 5) with the motive power force supplied by the flowing (W1) water mass, together with an Eductor assembly (E1 and E5). The suction function is the result of the (W1) motive water supply flowing through the jet pump.

The water flow passes thru the Venturi pipe exhausting system with a partial vacuum present in the Eductor pipe as it passes the Venturi constriction and out thru the jet nozzle. At the same time a flow is also moving along the outer (external) surfaces of the jet pump system. The ambient area in the vicinity of the Venturi jet nozzle exit point is in a vortex state with a lower pressure differential in the immediate front of the discharge jet nozzle. The stream of water or turbulence from the exhausting system exits and blends with the ambient flowing water stream pump chambers.

Downstream of the constriction the Venturi pipe regains its normal size. The pipe when fitted with a tapered nozzle produces a jet stream with downstream capitation which effects immediately in front of the jet discharge point. This facilitates the reentry of the drainage water into the ambient water mass flowing by the discharge vicinity.

The area (E7) in front of the mouth of the jet nozzle experiences a vortex/turbulence space with a lowered pressure differential. The turbulence is caused by efflux from the jet nozzle (E5) and the water current (W3) flowing across the external surface of the Venturi pipe (E6) with its blunt shaped exit point. This facilitates the reentry of water exiting the exhaust system of this embodiment.

The discharge thru E4 has lost part of its energy due to encountering the secondary stream at E1 which it includes as a combined stream. But it must be known that the pressure at the exit point E5 is largely determined by the ratio (volume) of the two streams. Since the primary stream W1 is not constrained in terms of force, being vast, it can have a favorable ratio in respect to the volume of the secondary stream from P5. This ratio advantage is not the ordinary case for an ordinary dam, which has economy/efficiency constraints.

### CONCLUSION, RAMIFICATIONS AND SCOPE

The conceptual basis for this enablement is, as follows:
a. The Science and Mechanics of fluid flow phenomenon;
b. Insights in application of existing old and new technologies;
c. Observation of the natural laws which regulate the affairs of the physical world;
   Developing a new approach to the energy solution is akin to solving a puzzle. Concepts and Themes must be brought into proper sequence and harmony:
a. Fossil fuels-overcoming our centuries old dependence on this limited resource which is causing harm to our environment and damage to our economy;
b. Environment-utilizing the Earth's natural advantages and laws without causing environmental damage to our planet;
c. Water-employing the unique properties of water, which is literally the perfect machine when understood and used in the proper working environment;
d. Gravity-utilizing this natural force, of water, acting in harmony with the laws of nature, by working with gravity, opposed to working against it. Thus, Submerged at a Depth provides working energy in the form of a hydraulic head;
e. Cavitation-understanding and utilizing the effect of movements by a body of water with pressure differential changes;
f. Jet pump-using the proven properties of the Venturi/Eductor principle to open a hole in a body of water to create an ever flowing machine;
g. Always-generating energy for as long as man exists on the Earth;
h. Associate-creating a recipe for functional integration of these themes;
i. Articulate-communicating concepts and information regarding the construction and utility of this enablement;

In summary, this enablement has a forever flowing water supply as a prime mover (W1) and consumes no matter, as it transforms energy from an infinite renewable source. It is readily replicated and produced for volume energy needs. This invention ensures a relatively inexpensive method of producing energy, without consuming any fuel or non-renewable resource, in a completely environmentally friendly manner. These are its principal advantages over other fossil-based systems in present use. This enablement is a new Paradigm which utilizes God's natural forces to bring a new method of energy generation to the World for all of its many potential uses to serve mankind.

What is claimed is:

1. An enablement that is a totally submerged power plant, which captures natural raw energy from flowing ocean current as its prime mover, thereby converting the natural energy of the water into electricity by reason of the Venturi/Eductor exhausting function, essentially performing the same function as a hydro-power dam. The form in which this captured raw energy is used can be the motive force in many embodiments, such as turbines, hydraulic motors, hydraulic rams, etc. Furthermore, having as a plant captured the natural raw energy, it can achieve even higher pressures (head) as a motive force to drive its turbine, if it is coupled and operated as a combined system, which includes a means for hydraulic pressure multiplication, which acts to increase the hydraulic head and reduce the volume of the flow itself. The resulting force can then can be used to power any number of embodiments within or outside the structure or above the surface of the water, such as desalination of water, electrolysis of water to create hydrogen as a liquid fuel and oxygen as a byproduct, or any other standard manufacturing or technological process or any other process requiring the use of electrical energy as a motive force. All of this is its capability, including supporting the power grid for down line distribution to other users. This enablement has all of the following critical attributes;
a. It is submerged in a moving body of water oriented to capture the force of the moving stream;
b. Its structure, consists of the components described herein to constitute an entire physical plant, the upper portion of which resides on and above the surface of the water, that is secured from moving from a fixed position in relation to the sea floor and that is oriented so that the input points face toward the incoming downstream current and in proper relationship to an offshore power grid electrical distribution system. Furthermore, it must be extended downward to the desired operating depth to provide the pressure (head) and the motive source to operate the system;
c. It derives its motive force from both the flow and pressure of the water as the prime mover for both the power and exhaust functions;
d. Having captured the raw energy in the form of hydro-power, it can be used by any embodiment of hydraulic machinery to transform the power into mechanical energy, which can then be the motive force for generating electrical power;
e. Having transformed this natural raw energy into its electrical form, it then can be used to power any number of embodiments within or outside the structure or above the surface of the water, such as the desalination of water, electrolysis of water to create hydrogen as a liquid fuel and oxygen as a byproduct, or any other standard manufacturing or technological process or any other process requiring the use of electrical energy as a motive force;
f. It can achieve even higher pressures (head) as a motive force to drive its turbine, if it is coupled and operated as a combined system, which includes a means for hydraulic pressure multiplication, which acts to increase the hydraulic head and reduce the volume of the flow itself. Also with an unlimited water supply, the enablement removes limitations on the size of the turbine runners thereby increasing the overall generating capacity of the system;
g. It is capable of continuously operating in all respects, as a complete power plant when submerged in a moving current at a depth;
h. The Penstocks of the enablement, which feed the system, have shrouded entrance ways, which embody the Venturi principle of increasing the incoming force being fed into the system;
i. The function of this enablement is designed to transform the raw energy from its environment by applying hydraulic technology, Venturi-Eductor technology and a computer synchronized control system;
j. The power plant of this enablement literally processes the water through a turbine to capture energy and the water is then returned to the surrounding body of water;
k. The Venturi/Eductor exhaust function of this enablement, which is independent of the power unit side, is powered by the water, as the prime mover;
l. This Venturi/Eductor exhaust function acts as a generic all purpose pump, which in effect, opens a vacant cavity or “hole” in the ocean. This same principle of this enablement could be used independently of this device in many other embodiments involving motive flows and pumping situations, which require discharges within any fluid environment;
m. As a motive stream flows through the Venturi-Eductor assembly with an entrainment chamber, the Eductor is the linkage between the power unit and the Venturi tube;
n. The suction created by the Eductor, clears the spent water from the power unit by entraining it within the Venturi jet pump for return to the surrounding body of water;
o. The efflux point for discharge is a nozzle and the form of the exit face itself, is blunt or truncated shape, which creates an area of turbulence, impeding the flow of water past the pump body itself;
p. The benefit of this process is taking the full raw energy of hydro-power and transforming it to mechanical energy;
q. The force of the water supply can drive a turbine, such as in the preferred embodiment using a Pelton wheel impulse turbine, which in turn, can drive an electrical generator;
r. All of these functions, being within the state of art for power generation, are performed in full compliance with Pascal's and Bernoulli's Equations concerning the laws of conservation of energy;
s. Thus, the enablement is a system with unlimited potential, capable of an infinite amount of electrical power production and expansion, which allows unlimited excess reserve power to be available as needed for all uses, by reason of the vastness of the water supply, as the motive force and of the unlimited locations for site placement;
t. This is a totally submerged power plant which captures raw energy from the streams or rivers moving within the oceans or upon land, as its prime mover, essentially performing the same function as hydro-powered dams, which have very limited water supply sources, site locations and other adverse environmental impacts;
u. The enablement makes use of an infinite renewable energy source and does not consume any matter in producing electrical energy.
